(19) United States
(12) Patent Application Publication
(10) Pub. No.: US 2009/0022874 A1
(43) Pub. Date: Jan. 22, 2009

(54) CREAMY OPAQUE POURABLE SALAD DRESSING

(75) Inventors: Leonardo Jose Sanchez AQUINO, Jersey City, NJ (US); Rosemary Antoinette GOLDEN, Franklin Park, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., d/b/a UNILEVER, Englewood Cliffs, NJ (US)

(21) Appl. No.: 11/779,665

(22) Filed: Jul. 18, 2007

(51) Int. Cl. A23L 1/24; A23L 1/0532

(52) U.S. Cl. 426/602

(57) ABSTRACT

A creamy opaque pourable and/or sprayable salad dressing containing a gum system having substantially no solids. The gum system includes carrageenan, xanthan gum and propylene glycol alginate. No creaming is observed with a salad dressing composition having an oil content of 10% or more, a water content of about 40% to about 75%, and a gum content of less than about 1%.

### FIELD OF THE INVENTION

The present invention is directed to a pourable, relatively non-viscous, salad dressing that is creamy, opaque, has an oil content of about 10% or more, and has substantially no solid particulates. More particularly, the present invention relates to suspension of oil in a system of a pourable, relatively non-viscous, salad dressing that is creamy, opaque, has an oil content of about 10% or more, and has substantially no solid particulates.

### BACKGROUND OF THE INVENTION

In 1851, George Gabriel Stokes derived an expression for the frictional force exerted on spherical objects with very small Reynolds numbers (e.g., very small particles) in a viscous fluid by solving the generally unsolvable Navier-Stokes equation:

F=6 π r η v

where:
F is the frictional force
r is the Stokes radius of the particle
η is the fluid viscosity, and
v is the particle's speed

If the particles are falling in the viscous fluid by their own weight, then a terminal velocity, also known as the settling velocity, is reached when the frictional force combined with the buoyant force exactly balance the gravitational force. The resulting settling velocity is given by:

$${V}_{s} = \frac{2}{9} \frac{{r}^{2} g ( {P}_{p} - {P}_{f} )}{η}$$

where:
Vₛ is the particles’ settling velocity (vertically downwards if Pₚ>P_{f}, upwards is Pₚ<P_{f})
g is the acceleration due to gravity,
Pₚ is the density of the particles, and
P_{f} is the density of the fluid

For pourable salad dressings, since the density of oil particles (i.e., oil droplets suspended in aqueous medium) is less than the density of the fluid, one skilled in the art would expect the oil droplets to go to the surface, i.e. vertically upwards. This undesirable phenomena is known as creaming.

Also, for pourable salad dressings, since the viscosity is relatively low, the upwards velocity of oil particles should be high, so that the creaming phenomena would be expected to be observed relatively quickly.

The more oil in the pourable salad dressing, the more of a problem creaming should be because, the more oil droplets in the system, the more likely they are to coalesce into particles of larger diameter, thereby increasing the upwards velocity.

The present invention is aimed at ameliorating this phenomenon. Additionally, for a more complete understanding of the above and other features and advantages of the invention, references should be made to the following detailed description of the preferred embodiments.

### ADDITIONAL INFORMATION

Wilson, et al., U.S. Pat. No. 6,544,573 discloses a gum combination for liquid condiment systems.

Marrs, European Patent Application No. 0 238 330 relates to modified emulsifiers for foods and creaming rates.

Breitbart, et al., U.S. Pat. No. 6,060,106 discloses an opaque low fat salad dressing aiming to achieve an improved mouthfeel.

None of the additional information addresses the creaming phenomenon by achieving no creaming which is more likely to occur with higher oil or fat contents, by using a particular gum system, and preferably no other emulsifiers or thickeners. According to the present invention, no creaming occurs over a shelf storage of at least about 5 to about 6 months, and preferably about ten (10) months; relatively high oil levels are emulsified with relatively low viscosity; and the inventive pourable composition is capable of being dispensed as a spray.

### SUMMARY OF THE INVENTION

The present invention is directed to a pourable and preferably sprayable, relatively non-viscous, salad dressing that is creamy, opaque, has an oil content of 10% or more, has substantially no solid particulates, exhibits no creaming over a shelf storage period of at least about 5 to about 6 months, and is capable of being dispensed as a spray. More particularly, the present invention relates to suspending of oil in a system of a pourable and/or sprayable, relatively non-viscous, salad dressing that is creamy, opaque, has an oil content of 10% or more, and has substantially no solid particulates. An advantageous feature of the present invention is that oil particles are suspended and remain so without creaming over the intended shelf life of the product, preferably about ten (10) months. Preferred sprayable creamy opaque salad dressing, such as creamy French, creamy Ranch, and creamy Honey Mustard, are disclosed in accordance with the inventive composition. The cramy opaque salad dressing is easily dispensed from a dispensing article whereby a discharge volume of salad dressing is discharged which is equivalent to about two (2) Calories per spray. The creamy opaque salad dressing composition of the present invention includes an aqueous system comprising water and a gum system. The water comprises about 40% to about 75% of the composition, preferably about 65% to about 75% water. A gum system is used to keep the emulsified oil particles suspended in the product composition. Preferably, substantially no other emulsifiers (e.g. lecithin) or thickeners (e.g. starch maltodextrin) are used. The gum svstem comprises a combination of xanthan gum, an alginate, and a carrageenan. Preferably the alginate is propylene glycol alginate and the carrageenan is iota carrageenan. The products of the invention will generally have about 1% or less of gums. Preferred amounts for the gums are 0.06% to about 0.09% of an alginate, about 0.12% to 0.20% carrageenan and about 0.10 to about 0.20% xanthan gum.

The food in which the invention is used is preferably a creamy opaque pourable and/or sprayable salad dressing, although the invention may be used to prepare other condiments that are creamy and opaque but relatively non-viscous. The compositions of the invention are generally oil and water emulsions and preferably include 10% triglycerides or more, preferably 10% to about 20% triglycerides. The triglyceride oil is most preferably soy bean oil used at about 12%. The products of the invention are preferably low viscosity products. For example, the products may have viscosities of 1000 cps and below, especially about 200 to about 500 cps, and more preferably a viscosity of about 400 cps.

Preferably, the salad dressing is substantially free of solid particulates. For example, tomato juice rather than puree is used to minimize solids. Substantially free of solid particulates as used herein means less than about 0.5% particulates having a particle diameter of 0.6 cm or more, based on total weight of the salad dressing composition.

Substantially free or substantially no, as used herein with reference to components other than the solid particulates discussed above, means less than about 0.5% based on total weight of the salad dressing composition.

Ambient as it refers to storage temperature herein means room temperature or temperatures in the range of about 60 to about 80 deg F. (about 15 to about 27 deg C.).

The term “comprising” is used herein in it ordinary meaning and means including, made up of, composed of, consisting and/or consisting essentially of. In other words, the term is defined as not being exhaustive of the steps, components, ingredients, or features to which it refers.

Except in the operating and comparative examples, or where otherwise explicitly indicated, all numbers in this description indicating amounts or ratios of material or conditions of reaction, physical properties of materials and/or use are to be understood as modified by the word “about”.

### DETAILED DESCRIPTION OF THE INVENTION

According to the present invention, a creamy opaque salad dressing composition includes, and preferably consists essentially of:

at least 10% triglyceride oil;

substantially no solids;

an aqueous phase comprising water and a gum system comprising a combination of carrageenan, xanthan gum, and alginate; wherein said water comprises about 40% to about 75% by weight of said salad dressing composition; wherein said gums comprise about 1% or less by weight of said salad dressing composition;

the composition exhibiting no creaming and being opaque.

Preferably, the inventive composition is pourable and is capable of being dispensed as a spray.

Triglyceride Oil

The oil present in the creamy opaque salad dressings is an important contributor to the taste, texture, appearance, aroma, mouthfeel, and appearance of the same. Any food grade triglyceride oils may be used in the salad dressing compositions, such as including but not limited to soybean oil, olive oil, canola oil, rapeseed oil, sunflower seed oil, safflower oil, avocado oil, mustard oil, and other plant oils, and mixtures thereof. Preferred are oils which are liquid at ambient temperature The triglyceride oil is used in an amount of at least 10%, and as high as about 65%, preferably 10% to about 20% triglycerides, most preferably about 12% oil. In a more preferred embodiment, the oil used in this invention is soybean, sunflower or rapeseed oil or a mixture thereof; most preferably soybean oil.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30%, and most preferably, at least about 75% of the total weight of the oil used in the composition.

Aqueous System

The creamy opaque salad dressing composition of the present invention includes an aqueous system comprising water and a gum system. Water is used in the composition to hydrate the dry ingredients and to provide a balance amount in the composition, preferably about 40% to about 75%. Especially preferred are compositions wherein the water comprises about 65% to about 75% of the composition, including all ranges subsumed therein.

Substantially free of solid particulates as used herein means less than about 0.5% particulates having a particle diameter of 0.6 cm or more. Examples of fine solids that may be used are mustard flour, salt, and tomato solids from tomato juice. Fine mustard flour may be used in an amount of less than about 0.5%.

Gum System

The gum system comprises a combination of xanthan gum, an alginate, and a carrageenan. Xanthan (otherwise called xanthan gum) is a microbial exopolysaccharide produced by the naturally occurring bacterium Xanthomonas campestris. Xanthan gum is commercially available and is preferably sourced under the trademark Xanthan SF in order to achieve a sprayable composition. Alginates may be found in and isolated from various organisms, in particular from algae belonging to the order Phaeophyceae and soil bacteria such as Azotobacter vinelandii and Azotobacter crococcum and from several strains of Pseudomonas bacteria. Carrageenans are sulphated galactans which are extracted from red seaweeds belonging to the families Gigartinaceae and Solieraceae. They are based on repeating units of 1,3-linked galactopyranose and 1,4-linked-3,6-anhydrogalactopyranose, and vary in sulphate content.

Preferably the alginate is propylene glycol alginate (most preferably Kelcoloid SVF from ISP Alginates) and the carrageenan is iota carrageenan. A preferred source of iota carrageenan in accordance with the invention is sold as Viscarin SD 389. The products of the invention will generally have about 1% or less of gums. Preferred amounts for the gums are 0.06% to about 0.08% of an alginate, about 0.12 to about 0.20% carrageenan and about 0.10 to about 0.20% xanthan gum, including all ranges subsumed therein.

In a preferred embodiment, substantially no other gums, emulsifiers (e.g. no lecithin), or thickeners (e.g. starch, maltodextrin) are employed in the inventive compositions in order to achieve a creamy opaque salad dressing that consumers demand while avoiding a “pasty” look and taste.

In addition to the ingredients mentioned above, the pourable creamy opaque salad dressing of the invention may include many other ingredients typical for such compositions. Vinegar is often used and may be red wine vinegar, distilled white vinegar, or corn sugar cider vinegar. Vinegar may be present at, for example, about 9% to about 15%. Various fruit and vegetable juices may be used, including apricot puree, tomato juice, onion puree, roasted garlic puree, garlic juice, onion juice, etc., as long as they do not exceed to specified solids content of solids of the specified minimum size.

Salt may be added in the form of sodium chloride granules. Salt is often included in an amount of about 2% to about 3%, preferably about 2.10 to about 2.40%. If desired, a blend of seasonings may be employed, such as mustard flour, onion flavor, garlic flavor, and other flavorings, as long as they do not exceed to solid particulates limitation required herein. Other ingredients typically used in liquid pourable salad dressings may also be included, such as sorbic acid, vitamin E, EDTA, and beta carotene for color.

The viscosity of the compositions may be adjusted to suit a particular product and to work with a particular dispenser variation. The products of the invention are preferably low viscosity products. The viscosity of the compositions may range from about 100 to about 1000 cps as measured on the Brookfield Viscometer, RVT, at room temperature and spindle speed of 110. Preferably, the viscosity ranges at about 200 cps to about 500 cps, more preferably, about 400 cps for the creamy opaque type salad dressing composition according to the present invention that is capable of being dispensed as a spray.

Preferred product specifications are as follows:

| PH | 2.85-3.30, more preferably 2.90-3.15 |
|---|---|
| ACID | .85-1.15 |
| SALT | 2.10-2.40% |
| VISCOSITY | 200-500 centipoise (at room or ambient temperature) |
| DENSITY | 1.055-1.085 |

In preparing the products of the invention, it is preferred to hydrate the stabilizers in water prior to mixing with other ingredients. The composition ingredients are then mixed and milled or mixed under high shear, such as in a colloid mill, in order to obtain the desired opacity.

Use

In use, the creamy opaque salad dressing composition may be poured onto a food, preferably a salad, or it may be dispensed as a spray from spray containers such as those available from the SeaquistPerfect Dispensing Company or from Saint Gobain Calmar Inc. or such as those disclosed in co-pending patent application Ser. Nos. 11/399,763 or 11/399,764. Preferably, a hand-held spray dispensing article is provided, comprising: a reservoir for receiving a liquid composition, the reservoir having a closed and an open end; an operating unit for dispensing the spray at least partially positioned over the reservoir at the open end, whereby said operating unit is in fluid communication with said reservoir, Preferably, a non-aerosol spray container is used. Most preferably, a spray container is used so as to deliver a uniform spray pattern of about 3 inches to about 5 inches in diameter when sprayed at a 45 degree angle to a surface while holding the sprayer at about 10 to about 12 inches from the surface at room temperature. Without wishing to be bound by theory, Applicants believe that the properties of viscosity and substantial lack of solids of the present composition allow it to be thick enough to provide an appearance and perception of creaminess while permitting the composition to be dispensed as a spray, and particularly in the described advantageous spray pattern.

A creamy opaque salad dressing product in an easy to use spray bottle based on a non-aerosol mechanical pump is preferably provided. The spray bottle delivers a consistent amount of product in every spray, having a discharge volume of about 0.75 ml per spray. Preferably, creamy product delivery amounts to about two (2) Calories per spray.

Several examples of application of the inventive system and method are described. The following is by way of example, not by way of limitation, of the principles of the invention to illustrate the best mode of carrying out the invention.

### EXAMPLES

### Example 1

A French Style creamy Vinaigrette salad dressing was prepared by mixing the following ingredients.

TABLE 1
French Style Creamy Vinaigrette Salad Dressing

| Ingredient | Percent |
|---|---|
| Water | BAL* |
| Defoamer | 0.003 |
| Titanium Dioxide Dispersion | 0.032 |
| Soybean Oil | 12.000 |
| Vinegar | 14.333 |
| High Fructose Corn Syrup 42 | 23.500 |
| Honey | 2.500 |
| Salt | 2.000 |
| Xanthan Gum - Keltrol SF | 0.122 |
| Carageenan Gum | 0.160 |
| Propylene Glycol Alginate (PGA LVF) | 0.064 |
| (ISP Alginates) | |
| Mustard Flour | 0.250 |
| Aquaresin Paprika | 0.155 |
| Calcium Disodium EDTA | 0.007 |
| Apple Cider Vinegar Toner | 0.026 |
| Flavor | 0.515 |
| Sorbic Acid | 0.060 |
| VJI Tomato Juice Clarified 906FP | 5.000 |
| TOTAL | 100.000 |

*BAL is balance to 100%.
STORAGE TEMPERATURE = AMBIENT
SHELF LIFE = 10 MONTHS FROM DOM (date of manufacture)

The ingredients as seen in Table 1 were mixed for 10 minutes. The product had a pH of 3.2, a Titratable Acidity (Ta) of 1.00, a density of 1.07 g/ml and a viscosity of 400 cps. The product appearance was medium orange opaque dressing with no visible particulate.

Further varieties of pourable/sprayable salad dressings according to the present invention were prepared having formulations in the Tables below.

TABLE 2
Ranch Salad Dressing

| INGREDIENT | PERCENT |
|---|---|
| WATER | BAL |
| ANTIFOAM | 0.003 |
| SOYBEAN OIL | 12.000 |
| IFF NAT SC FLAVOR LIQ SNO76624 | 0.075 |
| IFF EMC SOUR CREAM 60874 | 0.425 |
| DISTILLED VINEGAR - 120 GRAIN | 2.083 |
| CORN SYRUP 42/43 | 11.000 |
| SODIUM CHLORIDE GRANULAR | 1.800 |
| CALCIUM DISODIUM EDTA | 0.006 |
| SORBIC ACID | 0.085 |
| XANTHAN GUM - KELTROL SF | 0.140 |
| CARRAGEENAN GUM - VISCARIN | 0.200 |
| PGA LVF | 0.080 |
| LACTIC ACID - 50% | 0.500 |
| MONOSODIUM GLUTAMATE | 0.500 |
| VEGETABLE JUICES | 1.900 |
| TITANIUM DIOXIDE DISPERSION | 0.925 |
| SUGAR | 2.700 |
| PHOSPHORIC ACID 75% | 0.281 |
| AQUARESIN BLACK PEPPER - KALSEC 22- | 0.030 |
| 19-142 | |
| SODIUM BENZOATE | 0.015 |
| BETA CAROTENE SOLUTION - 2% CWS | 0.004 |
| RANCH AND OTHER FLAVORS | 0.361 |
| TOTAL | 100.00 |

TABLE 3
Honey Mustard Salad Dressing

| INGREDIENT | PERCENT |
|---|---|
| WATER | BAL |
| DISTILLED WHITE VINEGAR 100 GRAIN | 12.00 |
| HIGH FRUCTOSE CORN SYRUP | 15.50 |
| SUGAR | 6.50 |
| SOYBEAN OIL | 12.00 |
| DESSERT HONEY, D.GOLD | 3.00 |
| MUSTARD FLOUR | 0.45 |
| SODIUM CHLORIDE GRANULAR | 1.75 |
| PGA LVF | 0.07 |
| CARAGEENAN GUM | 0.13 |
| XANTHAN GUM - KELTROL SF | 0.16 |
| BETA CAROTENE SOLUTION | 0.06 |
| CARAMEL POWDER | 0.13 |
| Liquid Titanium dioxide dispersion | 0.20 |
| AQUARESIN BLACK PEPPER - KALSEC 22-19-142 | 0.01 |
| SORBIC ACID | 0.08 |
| FLAVORS | 1.29 |
| EDTA | 0.01 |
| | 100.00 |

All the formulations according to the present invention were sprayable.

### Example A

A creamy country Italian salad dressing was prepared having the ingredients listed in thetable below.

TABLE 4
CREAMY COUNTRY ITALIAN Salad Dressing

| Ingredients | % |
|---|---|
| WATER | BAL |
| VINEGAR | 9.89 |
| FRUIT & VEG. JUICES & PUREES | 2.22 |
| SUCROSE | 6.42 |
| SOYBEAN OIL | 5.00 |
| SODIUM CHLORIDE GRANULES | 2.00 |
| CARRAGEENAN | 0.20 |
| HERBS | 0.20 |
| XANTHAN GUM, | 0.17 |
| Keltrol TYPE “T” | |
| RED BELL Pepper | 0.15 |
| PEPPER GRAN. FLAVOR | 0.12 |
| PROPYLENE GLYCOL Alginate | 0.08 |
| SORBIC ACID | 0.05 |
| VITAMIN E | 0.02 |
| EDTA | 0.01 |
| | 100.00 |

The herbs, garlic and peppers were partially hydrated. To 100 pounds of the water was added a slurry including Keltrol T xanthan gum. Then the remaining oil was added. After 25 minutes, the remaining water was added. After 10 minutes the preservative, sugar, hydrated spices and herbs, fruit and vegetable purees, vinegar and salt were added.

The resulting salad dressings was translucent (not opaque) and was not capable of being sprayed.

Percentages herein are wt % unless indicated otherwise.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A creamy salad dressing composition comprising:
at least 10% triglyceride oil;
substantially no solids;
an aqueous phase comprising water and a gum system comprising a combination of carrageenan, xanthan gum, and alginate; wherein said water comprises about 40% to about 75% by weight of said salad dressing composition; wherein said gums comprise about 1% or less by weight of said salad dressing composition;
wherein said composition exhibits no creaming; and
wherein said composition is opaque.

2. The creamy opaque salad dressing composition according to claim 1 wherein said carrageenan comprises iota carrageenan.

3. The creamy opaque salad dressing composition according to claim 1 comprising about 10% to about 20% triglyceride oil.

4. The creamy opaque salad dressing composition according to claim 1, wherein said alginate is propylene glycol alginate.

5. The creamy opaque salad dressing composition according to claim 1 having a viscosity of less than about 1000 cps.

6. The creamy opaque salad dressing composition according to claim 1 having a viscosity of about 200 cps to about 500 cps.

7. The emulsion according to claim 1 comprising about 65% to about 75% water.

8. The creamy opaque salad dressing composition according to claim 1 having about 12% soybean oil.

9. The emulsion according to claim 1 comprising from 0.06 to about 0.08% of an alginate.

10. The emulsion according to claim 1 comprising about 0.12% to about 0.20% carrageenan.

11. The emulsion according to claim 1 comprising said xanthan at about 0.10% to about 0.20% xanthan gum.

12. The emulsion according to claim 1 further comprising about 9% to about 15% vinegar.

13. The emulsion according to claim 1 comprising about 2% to about 3% salt.

14. The salad dressing according to claim 14 wherein said salt is present at from about 2.10% to about 2.40%.

15. The salad dressing according to claim 1 which is a creamy opaque dressing selected from the group consisting of creamy French, creamy Ranch, and creamy Honey Mustard dressings.

16. The salad dressing according to claim 1 comprising 0.06 to 0.08 wt % of an alginate.

17. The salad dressing according to claim 1 having a pH of about 2.85 to about 3.30.

18. A creamy opaque salad dressing composition consisting essentially of:
at least 10% triglyceride oil;
substantially no solids;
an aqueous phase consisting of water and a gum system consisting of a combination of carrageenan, xanthan gum, and alginate; wherein said water comprises about 40% to about 75% by weight of said salad dressing composition; wherein said gums comprise about 1% or less by weight of said salad dressing composition; and
an acidifier;
wherein said composition exhibits no creaming.

19. The salad dressing according to claim 18 which is dispensable as a spray from a dispensing article.

20. The salad dressing according to claim 19, wherein a discharge volume of salad dressing is discharged which is equivalent to about two (2) Calories per spray.
